(19) United States
(12) Patent Application Publication
(10) Pub. No.: US 2005/0132682 A1
(43) Pub. Date: Jun. 23, 2005

(54) Binderless glass composite filter

(76) Inventor: C. Thomas Paul, Madison, CT (US)

Correspondence Address: CUNO INCORPORATED, 400 RESEARCH PARKWAY, P. O. BOX 1018, MERIDEN, CT, 06450-1018, US

(21) Appl. No.: 11/017,113

(22) Filed: Dec. 20, 2004

Related U.S. Application Data
(60) Provisional application No. 60/532,748, filed on Dec. 23, 2003.

(51) Int. Cl. B01D 46/00

(52) U.S. Cl. 55/486

(57) ABSTRACT

An innovative glass composite media for use in a fluid filtering device and, more particularly, to an innovative binderless glass composite media which essentially prevents the extraction of impurities from the glass composite media resulting in overall low extractables when utilized in pleated filter elements or other liquid filtration devices and to apparatus for manufacturing and processes for making such composite glass media.

### BACKGROUND OF THE INVENTION

The present disclosure relates to an innovative glass composite media for use in a fluid filtering device and, more particularly, to an innovative binderless glass composite media which essentially prevents the extraction of impurities from the glass composite media resulting in overall low extractables when utilized in pleated filter elements or other liquid filtration devices and to apparatus for manufacturing and processes for making such composite glass media.

Glass composite media are well known in the art. Previously, known prior glass fiber media sheets similar to those used in pleated cartridges conventionally included a thermal set resin binder to help maintain sheet integrity and to increase the tensile strength of the sheet. Further, such binders provided stiffness to the composite filtration media in order to assist the glass to form into a pleat if other materials in the composite filter media composite did not provide sufficient stiffness.

One recognized problem with such binders is that some binder components tended to be extracted into the filtrate in the presence of water or a solvent, such as, for example, alcohol and ketone. Some filtration applications such as in the beverage, micro electronics, bio-pharmaceutical and pharmaceutical industries require low extractables in their filtrate. Eliminating the thermal set binder from the glass filter media is believed to lower the amount of extractables present in the resulting filtrate. Currently, glass media used in known pleated cartridges are believed to all use at least one binder.

Their is an extensive body of knowledge concerning extractable material coming off a filter device. This prior art deals with the disclosure of specific binders necessary to make the composite media function.

The beverage, micro electronics, bio-pharmaceutical and pharmaceutical industries all have concerns about extractable material coming off a filter device during filter operations. Materials of construction used to make pleated filter devices are believed to most always generate some amount of extractable material. In the case of glass fiber media filters, according to the prior art known to the inventor of the present disclosure, it is believed that at least one binder is required to assist with providing the glass fibers with sufficient stiffness for pleated filtration operations. The at least one binder is conventionally utilized to provide the pleat with the requisite shape, provide the filtration media strength and prevent glass fiber release into the filtrate. As is known, these binders, as used with the glass fibers, can be a source of extraction material when exposed to solvents, water or other liquids. Prior art glass media pre-filters for the Bio-Pharm industries, known to the inventor of the present disclosure, contain at least one thermal set binder. In the past, the filtration industry has believed that media requires a binder to make the glass filter media sufficiently stiff for utilization in applications requiring pleated filtration elements. Further, most filter elements utilizing pleated glass media filters do not have a downstream non-glass filter media to catch binder or glass fibers that might migrate off the upstream glass media.

Specifically, the filter text book “Filters and Filtration Handbook,” by T. Christopher Dickenson, Elsevier Advance Technology, 1997, has a section on filtration media. Glass fiber filtration media sheets are described as having binder to bond fine fibers, as shown specifically at page 96, the disclosure of which is hereby incorporated by reference to the extent not inconsistent with present disclosure.

At the time of the present disclosure, no prior patents have been located by the inventor that discloses, suggests or teaches the elimination of thermal set binders from pleated filter elements comprising glass media used in filtration applications that require low or no extractables in the filtrate. However, some prior patents have been located that teach the requirement for having at least one binder to hold the glass media together and to provide sufficient stiffness when the filtration media is pleated.

Some examples of known patents, each of which are herein incorporated by reference to the extent not inconsistent with the present disclosure, follow:

U.S. Pat. No. 5,279,731 to Cook, Nigel J. D. et al of Pall Corporation issued Jan. 18, 1994 teaches that the pleated cartridge disclosed therein used glass fiber bonded with resin.

U.S. Pat. Nos. 5,800,586 and 5,948,344 to Cusick et al. of Johns Manville Intemnational Inc issued Sep. 1, and Sep. 7, 1999, a divisional of the aforementioned Patent, disclose a composite filter device with stiffening layers. In the summary of the invention, a binder is required to aid pleating and bond the glass fiber together. In the description of the preferred embodiments, bonding at the fiber intersections is described using acrylic, phenolic, ethylene/viniyl and SBR binders. The binders are described as required to stiffen the web, prevent delamination of the layers and prevent fibers from breaking loose during filtration operations.

Specific pleated pre-filter glass media being developed for the Bio Tech industry was initially determined to have high water extractables, particularly after autoclaving. Analysis of the extractables indicated that the extractables originated from the binder used to maintain the integrity of the glass filter media. As discussed above, glass media in pleated cartridges eventually uses at least one thermal set binder in order to provide proper form and sufficient tensile strength.

Thus, there is a need for a binderless glass composite filter for use with pleated filtration media that normally will not have sufficient tensile strength when utilized in a filter device to accommodate forward fluid pressure drops without the filtration media being damaged. Such binderless glass composite filter should include a membrane or non-woven filter media positioned downstream which will trap potentially shed glass fibers. Such binderless glass composite filter should provide filtrate having low liquid extractables because no binder is applied to the glass during the formation of the composite filter. Such binderless glass composite filter should include upstream and downstream support members for sufficient stiffness. Such binderless glass composite filter should include, presently preferably, a membrane member or a non-woven media, downstream of the glass media. Such binderless glass composite filter, if utilized with a pleated filter device, could optionally include a downstream filter media made from a membrane or tight non-woven for providing support for the upstream binderless glass media. Such binderless glass composite filter should provide lower solid extractables in the filtrate.

### SUMMARY OF THE DISCLOSURE

The present disclosure is directed a pleated filter element which includes at least one glass filter media sheet without the presence of any resin thermal set binder or binders followed by a downstream non-glass media to essentially trap any glass fibers originating from at least one binderless glass media itself from entering the filtrate during filtration operations. The composite glass filter media of the present disclosure, presently preferably, includes a membrane downstream of the glass media and, presently preferably, at least two support layers, at least one layer being position upstream and at least one layer being positioned downstream of the binderless glass filter media. These other non glass layers provide the glass composite filter with the requisite stiffness and in combination with a binderless glass composite filter, are relatively easy to fabricate into a pleated cartridge. The at least one down stream filter media essentially prevents any glass fiber or other solid extractables that might become dislodged during the filtration process from entering the filtrate.

### BRIEF DESCRIPTION OF THE DRAWINGS

FIG. 1 is a. schematic representation of a representative binderless glass composite filter of the present disclosure.

### DETAILED DESCRIPTION OF THE DISCLOSURE

The following define specific terms, as they are understood to be used in the present disclosure.

By the term “binder”, we mean a material, typically epoxy or acrylic resin, or other thermal set resin used to coat the fibers of a non woven web to give it form and tensile strength.

By the term “binderless”, we mean a non-woven fiber filter media made into flat sheet rolls without any resin binder, such as, for example, epoxy, acrylic or equivalent being utilized therein.

By the term “Composite Pleated Cartridge Filter”, we mean a filter device with longitudinal pleats wrapped around an inner core and placed into an outer cage having more than one media grade and which my have more than one layer of media thus an upstream and down stream layer.

By the term “Extractables”, we mean the material that is extracted from filter devices after being submerged in a liquid, such as, for example water or other liquid.

By the term “Glass filter media”, we mean a media made from very fine glass fibers that are cut into a short length and put into an aqueous solution. The fiber solution is subsequently deposited on a moving porous belt or drum to remove the water and form a continuous glass fiber mat. The glass used can be a mix of different fiber diameter size and length resulting in a composite of materials.

In response to a problem related to the presence of both liquid and solid extractables in the filtrate from pleated filter elements containing glass media, a binderless glass filter media was developed. When suppliers were surveyed with regard to the availability of glass media sheets without the presence of resin binders, none of the contacted suppliers had any such glass media sheets available. Upon prompting, one supplier successfully produced a glass media without resin binders as conventionally used to formulate the glass filter media.

The binderless glass media was manufactured into rolls and was then fabricated into pleated cartridges with polypropylene up and downstream supports and a nylon or PES membrane downstream of the binderless glass media. Upon testing, the fabricated pleated filtration cartridge was integral after water wet diffusion testing.

The binderless glass media was determined to have certain characteristics, with relation to the amount of square footage of the glass filter media may vary depending on the compactness used in fabricating the glass filter media. Also the binderless glass media was found to possibly be slightly thicker than the same material with binder. When assembled into a pleated composite filter element, the glass filter media includes a membrane or a non-woven layer of media downstream of the glass filter media in order to catch any glass fibers if such should be released during filtration operations. Membrane to trap any loose glass fibers is presently preferred, but a non-woven capable of trapping glass fibers could also be used.

The innovative pleated filter device which includes the binderless glass includes, in addition to the membrane, non-woven or equivalent filter media located downstream for trapping loose glass fiber and provide the binderless glass media with support, at least one support media downstream of the membrane, non-woven or equivalent filter media and at least one support media upstream of the binderless glass media.

As discussed above, glass filter media has conventionally been produced including a thermal set resin binder which is known to produce liquid extractables in filtrate, particularly after autoclavinig. The glass filter media produced had satisfactory appearance and was determined to be pleatable for use in pleated filter elements similar to those described in U.S. Pat. No. 6,315,130, to Olsen, assigned to the assignee of the present application, the disclosure of which is incorporated herein by reference to the extent not inconsistent with the present application.

### Composite Construction

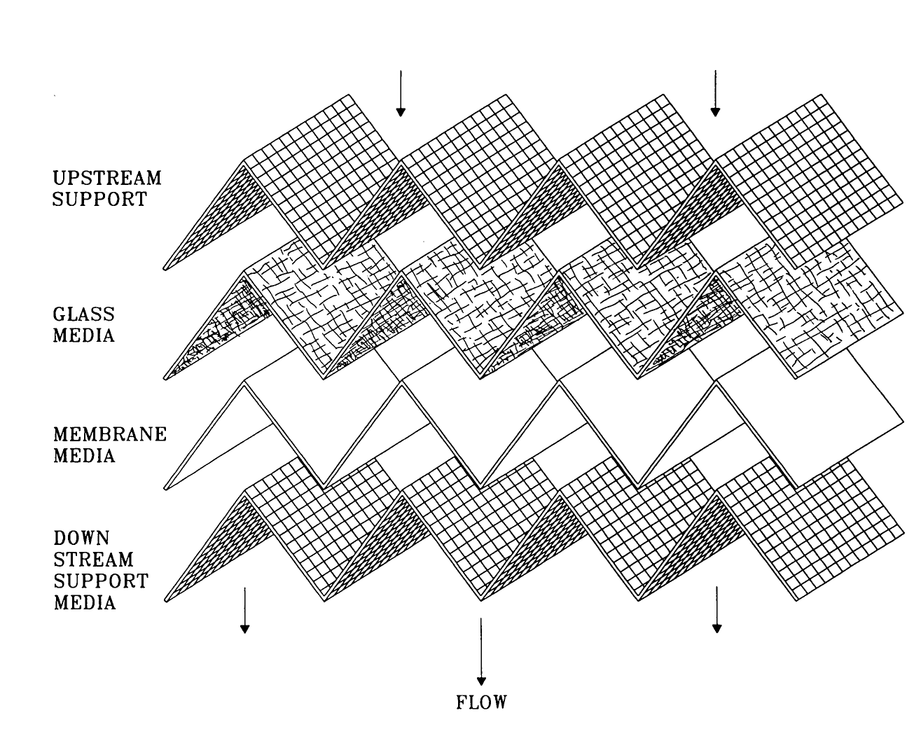

A representative binderless glass composite filter 10 of the present disclosure is shown in FIG. 1. Presently preferably, the binderless glass composite filter 10, of the present disclosure, comprises at least one upstream support medium 12, at least one downstream support medium 14, at least one binderless glass support medium 16 and at least one membrane medium 18 operatively positioned downstream from the binderless glass support medium Here, upstream and downstream refer to the exterior and interior surfaces of a filter element, as disclosed in the Olsen patent, when the filter is being subjected to radially inward fluid flow or to interior and exterior surfaces of the filter when the filter element is being subjected to radially outward fluid flow.

### Supports

While only one upstream and one downstream support media is shown in FIG. 1, it is contemplated that additional support media could be used as might be appropriate for various applications in which the innovative binderless glass composite filter of the present disclosure would be utilized. In one specific representative embodiment, the upstream supports comprise a spun bond, melt blown or extruded thermoplastic. One specific example of the spun bond support contemplated is a BBA non-woven Typar 309IL or equivalent. One specific example of an extruded support is Delstar Delnet 5 mil or equivalent. It is presently contemplated that the upstream and dowvnstream support can be the same material or possibly a combination of two different support materials, such as, 309IL non-woven upstream and 5 mil Delnet downstream.

Because the binderless glass composite filter of the present disclosure will most likely be utilized in pleated configurations, supports are necessary to provide the requisite stiffness. Because some pleated configurations are performed by rotary pleaders, the stiffness characteristic of the filtration media is of considerable importance to the production of a successful filtration system.

### Glass Media

The binderless glass media utilized in the present disclosure comprises glass wetlaid fibers formed without a resin polymer coating, such as, phenolic, epoxy or acrylic, for binding the glass fibers, as was used in the manufacture of conventional glass media to stiffen and hold the glass fibers together for filtration application.

### Downstream Filter Media

In addition to the up and down stream supports and the glass fiber media, an additional filter medium is provided located downstream of the glass media. This additional downstream media provides for a finer filtration step and for preventing any fine glass fibers that might come loose during the filtration from entering into the filtrate. Typical downstream filter media, as presently contemplated, comprises microporous membrane made with PES, nylon, Teflon or PVDF. Additional potential downstream media can also comprise calendared meltblowns or filled cellulosic filter media, such as, for example, Zetaplus.

The upstream and downstream media 12, 14 can be of the same or different construction. Alternatively, the upstream and downstream support media 12, 14 may have different characteristics and these characteristics may be varied to provide a desired effect. For example, where the overall thickness of the binderless glass filter composite is fixed, the thickness of the upstream diffusion medium 12 may be made greater than the thickness of the downstream support medium 14 or vice versa, as appropriate.

An example of a binderless glass filter composite 10 useful with a pleated filter element constructed according to the present disclosure includes an upstream medium 12 of Delnet® extruded polypropylene mesh, and a downstream medium 14 made of material, including but not limited to, for example, Typar T-135®, Typar 309IL, spunbond, non-woven polypropylene, available from Reemay Inc. Another example of a binderless glass filter composite 10 useful with a pleated filter element constructed according to the present disclosure includes an upstream support medium 12 made of material, including but not limited to, for example, Naltex Symmetrical Filtration Netting LWS® 37-3821 extruded polypropylene mesh, and a downstream medium 14 of the Typar T-135® spunbond, non-woven polypropylene.

The following represents actual experiments conducted to illustrate the concept described above.

### Extraction Experimenit Glass Miedia Bio-Pharm Pre-filter

The objective of the following example was to run a standard water extraction test on a 10 inch binderless glass media pre-filter to determine the affects of flushing, non-flushing, autoclaving and non-autoclave using filter media containing two different glass binders and one binderless glass filter media. The non glass upstream medias were built primarily for capacity testing. These media are included in the table below in order to obtain reference extractables.

Table 1 shows various upstream filter medias for the Pre-filter with different process conditions for running water extractables testing. 10 inch pleated cartridges using an advanced pleat configuration were utilized in the test. The glass media incorporated in the pleated filter was produced by the Lydall Corporation and referred to as the XL type. The thin Zetaplus and 1 MDS are commercially available from the assignee of the present patent application.

TABLE 1
Number of cartridges

| | | | | | No | No |
|---|---|---|---|---|---|---|
| Media | | notebook | | No Flush | autoclave | auto- |
| type | Binder | # | Flush | Autoclave | Autoclave | clave |
| Glass | Acrylic | 2684-183 | 1 | 1 | 1 | 1 |
| Glass | Epoxy | 2684-184 | 1 | 1 | 1 | 1 |
| Glass | none | 2684-185 | 1 | 1 | 1 | 1 |
| Zetaplus | | 2684-186 | 0 | 0 | 1 | 0 |
| 1 MDS | | 2684-187 | 0 | 0 | 1 | 0 |
| Total | | | 3 | 3 | 5 | 3 |

TABLE 2
Individual Cartridge information

| | | | | Water Flush |
|---|---|---|---|---|
| Cartridge # | Binder Surface | area sq ft | Autoclave | 3 GPM 10 min. |
| 2684-183-0004 | Acrylic | 5.1 | Yes | Yes |
| 2684-183-0009 | Acrylic | 5.3 | No | ″ |
| 2684-183-0006 | Acrylic | 5.3 | Yes | No |
| 2684-183-0008 | Acrylic | 5.3 | No | ″ |
| 2684-184-0002 | Epoxy | 5.8 | Yes | Yes |
| 2684-184-0006 | Epoxy | 5.4 | No | ″ |
| 2684-184-0003 | Epoxy | 6.3 | Yes | No |
| 2684-184-0007 | Epoxy | 5.9 | No | ″ |
| 2684-185-0006 | None | 4.9 | Yes | Yes |
| 2684-185-0008 | None | 5.1 | No | ″ |
| 2684-185-0004 | None | 5.3 | Yes | No |
| 2684-185-0009 | None | 5.3 | No | ″ |
| 2684-186-0001 | Zetaplus | 5.3 | Yes | ″ |
| 2684-187-0005 | 1 MDS | 5.0 | Yes | ″ |

The purpose of the experiment was to determine the total gravimetric non-volatile extractables (TGNVE) produced by a four (4) hour water extraction on the submitted pre-filter 10″ glass media cartridges.

### Samples

A total of fourteen 10″ glass media cartridges were submitted for evaluation. The following table 3 lists individual cartridge information.

TABLE 3

| Cartridge # | Binder | Surface area sq ft | Autoclave | Water flush |
|---|---|---|---|---|
| 2684-183-0004 | Acrylic | 5.1 | Yes | Yes |
| 2684-183-0009 | Acrylic | 5.3 | No | Yes |
| 2684-183-0006 | Acrylic | 5.3 | Yes | No |
| 2684-183-0008 | Acrylic | 5.3 | No | No |
| 2684-184-0002 | Epoxy | 5.8 | Yes | Yes |
| 2684-184-0006 | Epoxy | 5.4 | No | Yes |
| 2684-184-0003 | Epoxy | 6.3 | Yes | No |
| 2684-184-0007 | Epoxy | 5.9 | No | No |
| 2684-185-0006 | None | 4.9 | Yes | Yes |
| 2684-185-0008 | None | 5.1 | No | Yes |
| 2684-185-0004 | None | 5.3 | Yes | No |
| 2684-185-0009 | None | 5.3 | No | No |
| 2684-186-0001 | Zetaplus | 5.3 | Yes | No |
| 2684-187-0005 | 1 MDS | 5.0 | Yes | No |

### Procedure

The (see table above) cartridges were wrapped in a blue Bio-Shield® wrapping paper and autoclaved for about one hour at about 121° C. Each cartridge was placed in a 2 L glass graduated cylinder containing about 1400 mL of DI water and a stir bar. The cartridges were allowed to fill with water and submerge. The cartridges were extracted for about four (4) hours at about room temperature with the solution being slowly stirred. A cylinder containing only about 1400 mL of DI water and a stir bar served as a blank.

After about four (4) hours, the extraction procedure was ended. The cartridges were removed from the cylinders and allowed to drain into their respective cylinders for about twenty (20) minutes. The stir bars were removed from the cylinders and the volume of solvent remaining in each cylinder was recorded.

The extracting solutions were quantitatively transferred into separate 2 L beakers. The beakers then were placed on a hot plate and heated at an elevated temperature until the volume decreased to about 50 mL. Then the solutions were quantitatively transferred into pre-weight aluminum pans and brought to near dryness.

The final weights of the extracted residues were obtained in the aluminum pans after being taken to complete dryness at about 105° C. in a gravity convection oven using about thirty (30) minute drying and about thirty (30) minute desiccation cycles.

### Results and Discussion

The following table 4 lists the normalized TGNVE Results

TABLE 4

| | | | | Normalized |
|---|---|---|---|---|
| Cartridge ID | Binder | Autoclave | Water flush | TGNVE (mg) |
| 2684-183-0004 | Acrylic | Yes | Yes | 295 |
| 2684-183-0009 | Acrylic | No | Yes | 40.8 |
| 2684-183-0006 | Acrylic | Yes | No | 353 |
| 2684-183-0008 | Acrylic | No | No | 151 |
| 2684-184-0002 | Epoxy | Yes | Yes | 462 |
| 2684-184-0006 | Epoxy | No | Yes | 56.8 |
| 2684-184-0003 | Epoxy | Yes | No | 443 |
| 2684-184-0007 | Epoxy | No | No | 133 |
| 2684-185-0006 | None | Yes | Yes | 202 |
| 2684-185-0008 | None | No | Yes | 29.6 |
| 2684-185-0004 | None | Yes | No | 248 |
| 2684-185-0009 | None | No | No | 102 |
| 2684-186-0001 | Zeta plus | Yes | No | 85.9 |
| 2684-187-0005 | 1MDS | Yes | No | 154 |

All glass fiber cartridges, regardless of binder type or binder presence exhibited increased TGNVE levels if the cartridges were autoclaved. Flushing the cartridges significantly lowered the TGNVE levels only if the cartridges were not first autoclaved. Once autoclaved flushing with water had minimal to no effect on lowering the TGVNE levels regardless of binder type or binder presence. In all pretreatment cases except, no autoclave and no water flush, the cartridge's extractable levels, ranked highest to least were, epoxy binder, acrylic binder, no binder.

The following table 5 shows the results for glass media—PES membrane 10 inch cartridge filter device water extractables testing. One cartridge has a 30 minute 135° C. in-line steam test exposure before a 30 gallon flush of DI water and the other has just the same water flush.

TABLE 5

| | Resin | | | Normalized |
|---|---|---|---|---|
| Cartridge ID | Binder | Inline steam | Water flush | TGNVE (mg) |
| 2845-117-0005 | None* | No | Yes | 44.4 |
| 2845-117-0006 | None* | Yes | Yes | 36.1 |

*no thermal set binder resins (contains low % ethylene-propylene fibers)

The values of 44.4 mg and 36.1 mg extractables for the above cartridges are low when compared to autoclaved glass—membrane cartridges that contain Acrylic or Epoxy binder resins which were 295 mg and 462 mg respectively.

### Conclusion

Based upon the above reported results, cartridges that had been water flushed and not autoclaved produced the least amount of TGVNE regardless of binder type or binder presence. Once autoclaved, water flushing had minimal to no effect in reducing the amount of extractables regardless of binder type or binder presence. In general cartridges containing the epoxy binder produced the highest amount of extractables regardless of the pretreatment.

Thus, it should be clear from the above examples that the binderless glass composite filter of the present disclosure has met the objectives of at least reducing if not totally eliminating liquid extractables which had previously resulted form resin binders utilized in glass media as well as solid extractables attributable to glass fiber residue when the filter sheets were made without binders.

While the articles, apparatus and methods for making the articles contained herein constitute preferred embodiments of the disclosure, it is to be understood that the disclosure is not limited to these precise articles, apparatus and methods, and that changes may be made therein without departing from the scope of the appended claims.

1. A pleated glass composite filter element comprising:
at least one glass filter media substantially void of any resin coated or thermal set resin binder;
at least one downstream non-glass filter media, operatively positioned relative to the at least one glass filter media, for essentially trapping any glass fibers originating from the at least one glass filter media during the filtration process; and
at least two support layers, operatively positioned relative to the at least one glass filter media and the at least one downstream non-glass filter media, for providing sufficient stiffness to operatively form a pleated glass composite filter element, at least one support layer being positioned upstream and at least one support layer being positioned downstream of the at least one glass filter media.

2. The pleated glass composite filter element of claim 1 wherein the at least one down stream filter media essentially prevents any glass fiber or other solid extractables that might become dislodged during the filtration process from entering the filtrate during filtration operations.

3. The pleated glass composite filter element of claim 2 wherein the at least one downstream non-glass filter media comprises:
a membrane.

4. The pleated glass composite filter element of claim 1 wherein the resulting binderless glass composite filter is relatively easy to fabricate into a pleated cartridge.

5. The pleated glass composite filter element of claim 1 wherein the upstream supports comprise:
a spun bond, melt blown or extruded thermoplastic.

6. The pleated glass composite filter element of claim 5 wherein the spun bond support comprises:
a BBA non-woven Typar 309IL or equivalent.

7. The pleated glass composite filter element of claim 5 wherein the spun bond support comprises:
an extruded support is Delstar Delnet 5 mil or equivalent .

8. The pleated glass composite filter element of claim 5 wherein the downstream filter media comprises:
PES, nylon, Teflon or PVDF microporous membrane.

9. The pleated glass composite filter element of claim 5 wherein the downstream media comprises:
calendared meltblowns or filled cellulosic filter media, such as, for example, Zetaplus.

10. The pleated glass composite filter element of claim 2 wherein the thickness of the downstream diffusion medium may be made greater than the thickness of the upstream support medium.

11. The pleated glass composite filter element of claim 2 wherein the thickness of the upstream diffusion medium may be made greater than the thickness of the downstream support medium.

12. The pleated glass composite filter element of claim 1 wherein the upstream supports comprise:
Delnet® extruded polypropylene mesh.

13. The pleated glass composite filter element of claim 5 wherein the downstream medium comprises:
Typar T-135®, Typar 309IL, spunbond, non-woven polypropylene, available from Reemay Inc.

14. The pleated glass composite filter element of claim 5 wherein the upstream support medium comprises:
Naltex Symmetrical Filtration Netting LWS® 37-3821 extruded polypropylene mesh.

15. The pleated glass composite filter element of claim 5 wherein the downstream medium comprises:
Typar T-135® spunbond, non-woven polypropylene.

16. A method of manufacturing a pleated glass composite filter element comprising the acts of:
providing at least one glass filter media substantially void of any thermal set resin binder;
providing at least one downnstream non-glass filter media, operatively positioned relative to the at least one glass filter media; and
providing at least two support layers, operatively positioned relative to the at least one glass filter media and the at least one downstream non-glass filter media, at least one support layer being positioned upstream and at least one support layer being positioned downstream of the at least one glass filter media.
